(19) United States
(12) Patent Application Publication
(10) Pub. No.: US 2003/0214945 A1
(43) Pub. Date: Nov. 20, 2003

(54) Packet switch and method of forwarding packet

(76) Inventor: Hidetoshi Kawamura, Fukuoka (JP)

Correspondence Address: KATTEN MUCHIN ZAVIS ROSENMAN, 575 MADISON AVENUE, NEW YORK, NY, 10022-2585, US

(21) Appl. No.: 10/369,961

(22) Filed: Feb. 19, 2003

(30) Foreign Application Priority Data
May 20, 2002 (JP) 2002-145030

(51) Int. Cl. H04L 12/56

(52) U.S. Cl. 370/389; 370/392

(57) ABSTRACT

A packet switch able to balance (disperse) a packet traffic load of a network provided with at least a plurality of routing tables allotted with information of different outgoing ports for at least one destination address (DA); a table selecting unit for selecting any of the plurality of routing tables in accordance with a combination of at least a sender address (SA) and the destination address (DA) of an incoming packet; and a switch unit for sending the incoming packet to the outgoing port allotted to the destination address (DA) in the selected routing table.

### BACKGROUND OF THE INVENTION

1. 1. Field of the Invention

The present invention relates to a packet switch and a method of forwarding a packet, more particularly relates to a packet switch, for example, a router, and a method for forwarding an incoming packet to a corresponding outgoing route according to a destination address thereof.

2. Description of the Related Art

Along with the rapid increase in traffic of IP (Internet Protocol) packets in recent years, expansion of IP networks, more efficient utilization of network resources, and improvement of transmission quality have been demanded.

When using the packet switch and packet forwarding method according to the related art, however, it is becoming difficult to satisfy the above demands. This related art will be explained in detail by referring to FIG. 6 and FIG. 7.

According to the related art, there are the following problems.

Namely, according to the conventional system, irrespective of the fact there are actually a plurality of paths between an IP_SW1 and IP_SW3 shown in FIG. 6, the traffic concentrates at a specific path. Therefore, the path became congested and packet transfer delay and packet loss sometimes occurred.

### SUMMARY OF THE INVENTION

An object of the present invention is to provide a packet switch and method of forwarding a packet able to balance (disperse) the packet traffic load of a network.

To attain the above object, a packet switch of the present invention is basically comprised of the following two means at least. Namely, it is provided with a plurality of routing tables #1 to #N allotted with information TxPi to TxPj etc. of different outgoing ports with respect to at least one destination address DA; a table selecting means 2 for selecting any of the plurality of routing tables in accordance with a combination of at least a sender address SA and the destination address DA of the incoming packet; and a switch means 3 for sending the incoming packet to the outgoing port allotted to the destination address DA in the selected routing table. By this, it becomes possible to balance (disperse) the packet traffic load of the network.

### BRIEF DESCRIPTION OF THE DRAWINGS

The above object and features of the present invention will be more apparent from the following description of the preferred embodiments given with reference to the accompanying drawings, wherein:

FIG. 1 is a view for explaining a principle of the present invention;

FIG. 2 is a first part of a view of the configuration of principal parts of a packet switch according to an embodiment of the present invention;

FIG. 3 is a second part of a view of the configuration of principal parts of a packet switch according to an embodiment of the present invention;

FIG. 4A is a block diagram of a domain determining unit according to an embodiment of the present invention;

FIG. 4B is a view for explaining FIG. 4A;

FIG. 5 is a view of forwarding control of an IP packet according to an embodiment of the present invention;

FIG. 6 is a first part of a view explaining the related art; and

FIG. 7 is a second part of a view explaining the related art.

### DESCRIPTION OF THE PREFERRED EMBODIMENTS

Before describing the embodiments of the present invention, the related art and the disadvantages therein will be described with reference to the related figures.

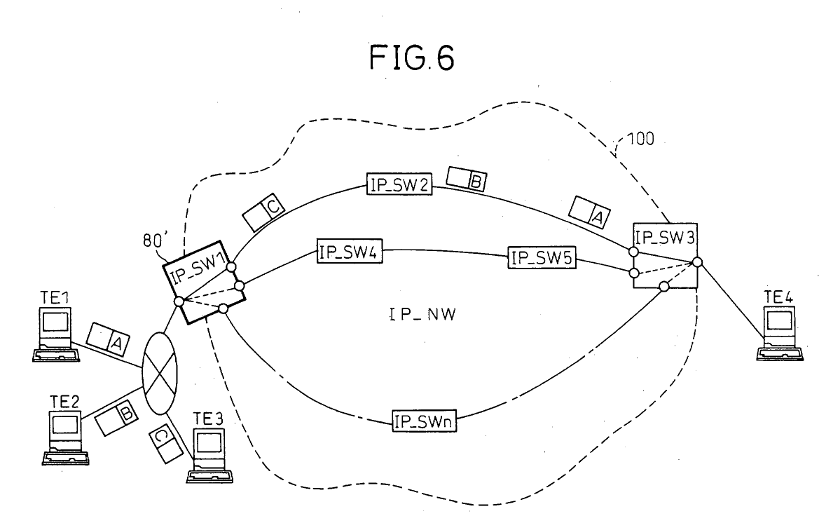

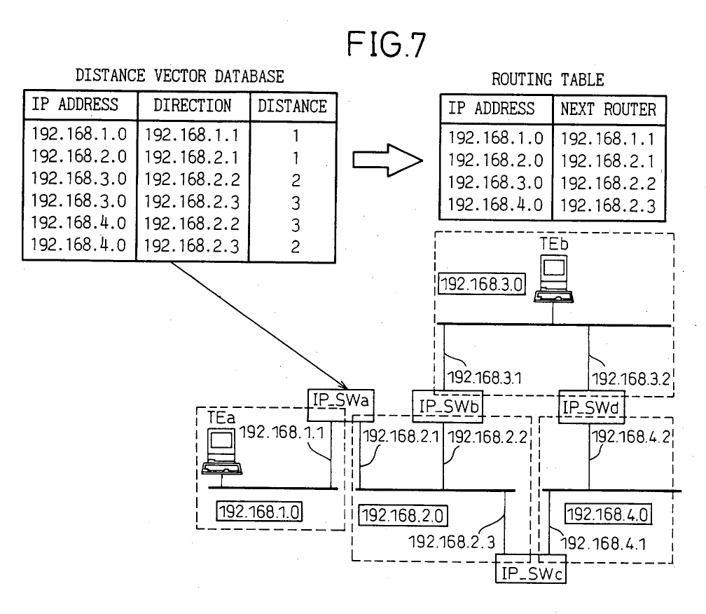

FIG. 6 and FIG. 7 are first and second parts of a view explaining the related art.

FIG. 6 shows a conventional IP packet routing (forwarding) method. In the figure, TE is a terminal equipment (host), IP_SW is a packet switch (router, etc.) and 100 is an IP network (IP_NW).

Terminal equipment TE1 to TE3 are connected to a remote terminal equipment (server or the like) TE4 via the IP_NW 100. Here, a router 80′ (IP_SW1) is treated as an edge router entering into the IP_NW 100. When assuming that IP packets A to C are transmitted together from the terminal equipment TE1 to TE3 to the terminal equipment TE4, conventionally, a route having the smallest number of hops (distance) is selected in the router 80′. For this reason, all IP packets A to C were transmitted via the same path (the uppermost path in the figure) to the IP_SW3.

FIG. 7 shows an image of processing of routing information protocol (RIP) for the routing of FIG. 6. In the figure, four networks “192.168.1.0” to “192.168.4.0” including terminal equipment TEa and TEb are connected to each other via four routers IP_SWa to IP_SWd. When looking at the processing for preparation of the routing table in the router IP_SWa, first, a distance vector database as illustrated is prepared according to the route information periodically transferred among the routers.

Namely, when seen from the router IP_SWa, there is a single route reaching “192.168.1.0”, that is, “192.168.1.1”, and the distance (number of hops) is “1”. Also, there is a single route reaching “192.168.2.0”, that is, “192.168.2.1”, and the distance is “1”. Further, there are two routes reaching the network “192.168.3.0”. If the route “192.168.2.2” is used, the network “192.168.3.0” is reached with the distance of “2”, while if the route “192.168.2.3” is used, the network “192.168.3.0” is reached with the distance of “3”. Also, there are two routes reaching the network “192.168.4.0”. If the route “192.168.2.2” is used, the network “192.168.4.0” is reached with the distance of “3”, while if the route “192.168.2.3” is used, the network “192.168.4.0” is reached with the distance of “2 ”.

Conventionally, based on such a distance vector database, connection to the target terminal equipment TEb is enabled with the shortest distance (smallest number of hops). For this reason, the routing table as illustrated was prepared. Accordingly, the routing method becomes that as shown in FIG. 6.

As mentioned above, according to the conventional system, irrespective of the fact that there are actually a plurality of paths between the IP_SW1 and the IP_SW3 shown in FIG. 6, traffic concentrates at a specific path. For this reason, the path was congested, and transfer delay and packet loss sometimes occurred.

The present invention was made in consideration of the problem of the related art and provides a packet switch and method of forwarding a packet able to balance (disperse) the packet traffic load of the network. Below, the principle and embodiments of the present invention will be explained in detail.

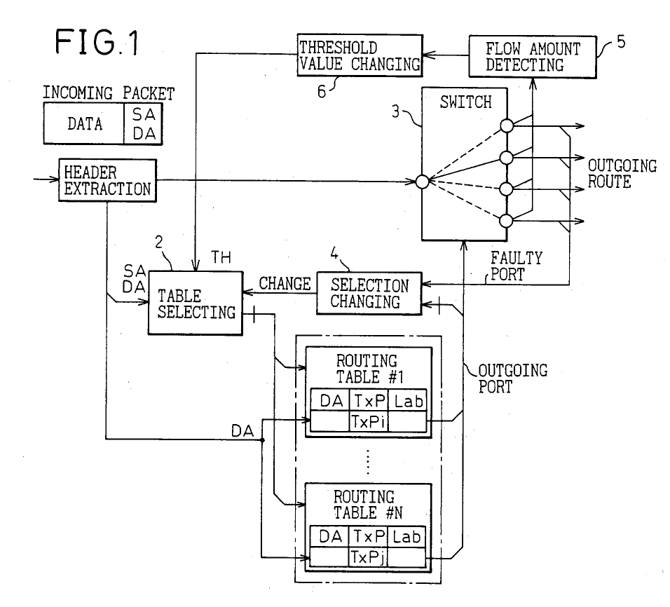

FIG. 1 is a view explaining the principle of the present invention.

The object of the invention is realized by for example the configuration of FIG. 1. Namely, a packet switch according to a first aspect of the present invention is provided with a plurality of routing tables #1 to #N allotted with information TxPi to TxPj etc. of different outgoing ports with respect to at least one destination address DA; a table selecting means 2 for selecting any of the plurality of routing tables in accordance with a combination of at least a sender address SA and the destination address DA of the incoming packet; and a switch means 3 for sending the incoming packet to the outgoing port allotted to the destination address DA in the selected routing table. By this, it becomes possible to balance (disperse) the packet traffic load of the network.

According to the packet switch of the first aspect of the present invention, provision is made of a plurality of routing tables #1 to #N allotted with the information of the different outgoing ports (TxPi to TxPj) with respect to at least one destination address DA. Therefore, by optimally using them, balancing control of the packet traffic (dispersal of the forwarding path) easily becomes possible. Also, the table selecting means 2 selects any of the plurality of routing tables in accordance with the combination of at least the sender address SA and the destination address DA of the incoming packet. For this reason, it becomes possible to efficiently forward a large number of packets transmitted all together from for example a plurality of different sender terminals (SA) to the same destination terminal (server etc.) (DA) while distributing the same to a plurality of paths. Thus, it becomes possible to disperse the traffic load and raise the forwarding efficiency.

According to a packet switch of a second aspect of the present invention, provision is made of the first aspect of the present invention wherein a selection changing means 4 for re-selecting another routing table if it is detected that the outgoing port obtained from the selected routing table is a faulty port and then sending the packet to the outgoing port allotted to the destination address in the re-selected routing table.

According to the second aspect of the present invention, even if a fault occurs in an outgoing route (outgoing port, outgoing path, etc.), it becomes possible to automatically switch the faulty route to a bypass route. Accordingly, improvement of the reliability with respect to the network can be achieved.

According to a packet switch of a third aspect of the present invention, provision is made of a packet switch for sending an incoming packet to a corresponding outgoing port in accordance with a destination address thereof, provided with a plurality of routing tables #1 to #N wherein information TxPi to TxPj of the different outgoing ports able to reach the destination address are defined for the same destination address DA; a table selecting means 2 for performing predetermined processing with respect to the information of the pair of the sender address SA and the destination address DA of the incoming packet and selecting the corresponding routing table based on a result of judgement of a predetermined threshold value for a value obtained by the processing; and a switching means 3 for searching through the selected routing table by the destination address DA of the incoming packet and sending the packet to the route based on the information of the outgoing port obtained by the search.

According to a packet switch of a fourth aspect of the present invention, provision is made of the third aspect of the present invention wherein provision is made of a detecting means 5 for detecting the information of a flow amount of packets passing through the outgoing port and the routing table routing the packet to the outgoing port for every outgoing port and a threshold value changing means 6 for changing the threshold value TH in the table selecting means 2 according to the thus detected information.

According to the fourth aspect of the present invention, load dispersal processing becomes possible according to the state of use of the lines (paths). Further, fluctuations in load of the network can be tracked and flexibly handled.

A packet forwarding method of the present invention is a packet forwarding method for forwarding an incoming packet to a corresponding outgoing route according to a destination address thereof, comprised of a step of providing a plurality of routing tables defining information of different outgoing ports able to reach a destination address for the same destination address, performing predetermined processing with respect to the information of a pair of a sender address and destination address of an incoming packet, and selecting a corresponding routing table based on the result of judgement of a predetermined threshold value for a value obtained by the processing and a step of searching through the selected routing table by the destination address of the incoming packet and forwarding the packet to the route based on the information of the outgoing port obtained by the search.

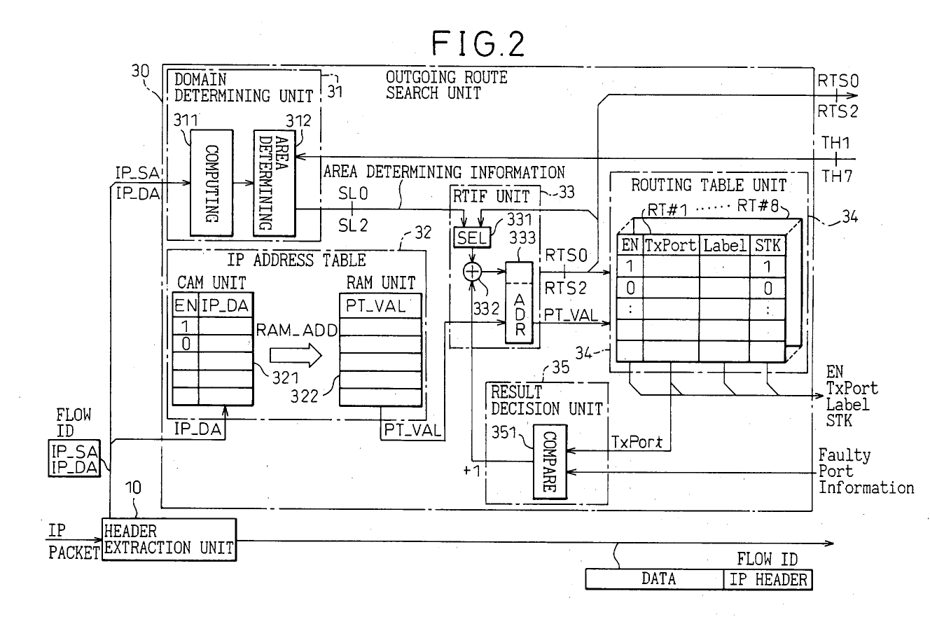

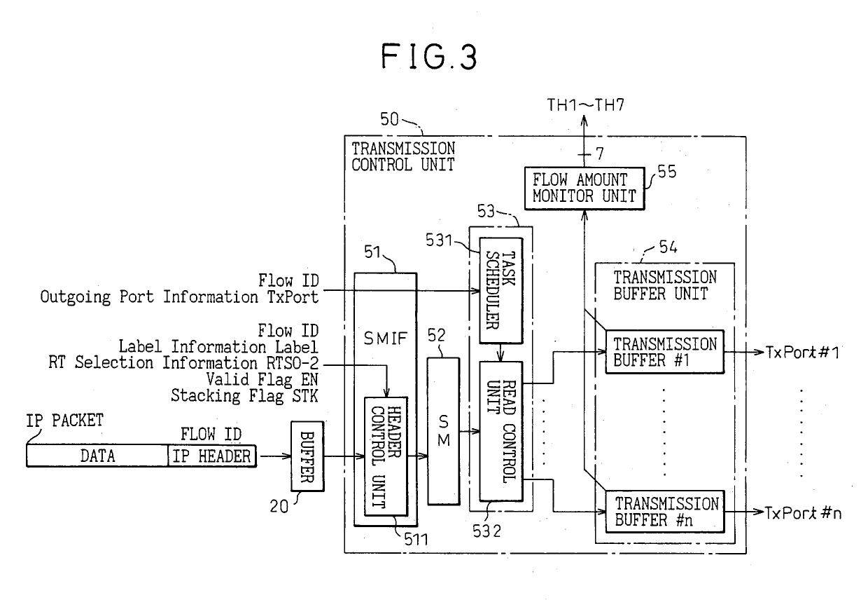

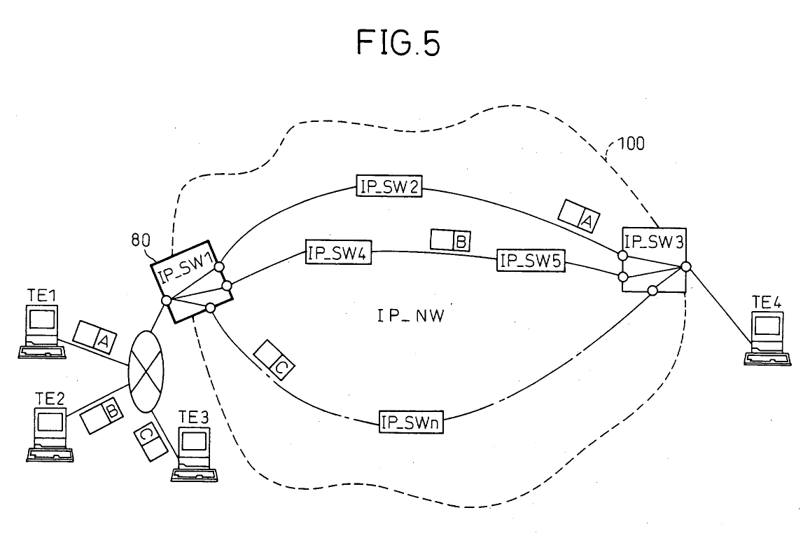

Below, a preferred embodiment of the present invention will be explained in detail according to the attached drawings. Note that the same references indicate the same or corresponding parts throughout all of the figures. FIG. 2 and FIG. 3 are parts of a view of the configuration of principal parts of a packet switch (router) 80 (shown in FIG. 5) according to an embodiment of the present invention. That is, they show a case preferred when applied to an edge router (IP_SW1) entering into the IP network 100.

In FIG. 2, reference numeral 10 is a header extraction unit for extracting IP header information from an incoming packet; 30 is an outgoing route search unit for searching for an outgoing route (outgoing port information) of a packet based on the extracted header information; 31 is a domain determining unit for performing predetermined processing with respect to information for the pair of the sender address IP_SA and the destination address IP_DA of the incoming packet and judging a threshold value of the domain (area) including the value obtained by the processing; 32 is an IP address table for outputting pointer information PT_VAL of the routing table (mentioned later) according to the destination address IP_DA of the incoming packet; 33 is a routing table IF (interface) unit for generating access information for the routing table unit 34 based on the area determining information SL0 to SL2 of the domain determining unit 31 and the pointer information PT_VAL from the IP address table 32; 34 is a routing table unit provided with a plurality of routing tables RT#1 to RT#8 definining information of the different outgoing ports TxPort able to reach a destination address for the same destination address IP_DA; and 35 is a result decision unit for comparing the information of the outgoing port output from the routing table unit 34 with the information of the separately detected faulty port and inputting the comparison result to the routing table IF unit 33.

In FIG. 3, reference numeral 20 is a packet buffer for temporarily storing an incoming packet; 50 is a transmission control unit for transmitting the packet of the packet buffer 20 to an outgoing route corresponding to the outgoing route information searched for at the outgoing route search unit 30; 51 is a shared memory IF unit (SMIF); 52 is a shared memory (SM) for controlling the switching of the IP packet to each outgoing route; 53 is a transmission scheduler for controlling the transmission of the IP packet to each outgoing route according to the band for each route; 54 is a transmission buffer unit provided with transmission buffers #1 to #n for every outgoing route; and 55 is a flow rate monitor unit for detecting the flow amount of packets passing through the outgoing port and information of the routing table routing the packet to the outgoing port for every outgoing port and generating/changing threshold values TH1 to TH7 applied to the area determining unit 312 according to the detected information.

The routing operation of an IP packet will be explained in detail below based on such a configuration. In FIG. 2, the header information (IP_SA, IP_DA) in the incoming packet is extracted at the header extraction unit 10. A flow ID indicating the processing number is placed in this extracted information, then the thus obtained information is notified to the outgoing route search unit 30. On the other hand, the incoming packet (data portion) is assigned a flow ID identical to the flow ID placed in the header information. The above incoming packet assigned this flow ID is stored in the packet buffer 20 (FIG. 3) until the search result of the outgoing route is obtained.

The address information IP_SA and IP_DA extracted at the extraction unit 10 are input to the domain determining unit 31. Here, predetermined processing (such as Hash processing) and judgement of the threshold value for the result of processing are carried out so that, even with the identical destination address IP_DA, the incoming packet is routed (load dispersed) to a different network path in accordance with a different sender address IP_SA.

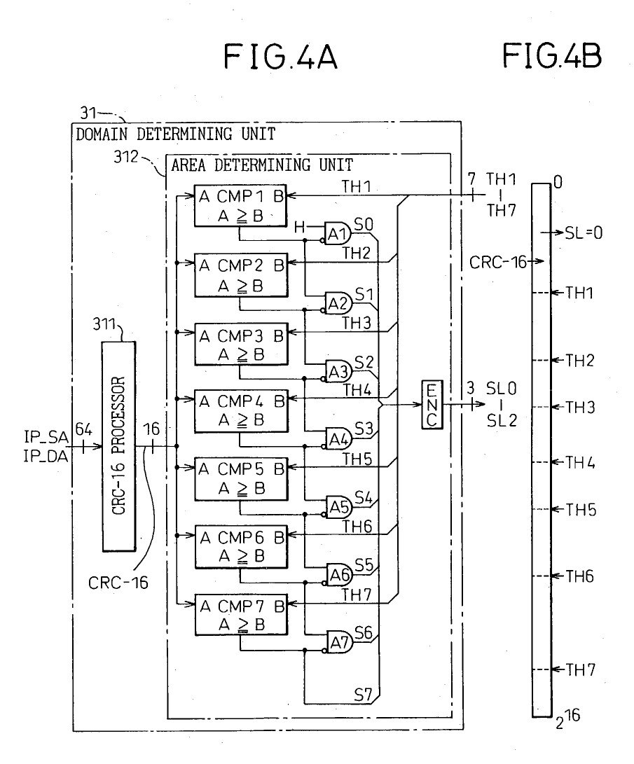

FIG. 4A is a block diagram of an example of the domain determining unit 31. This domain determining unit 31 is provided with, as an example, a CRC-16 processor 311 for performing the Hash processing and an area determining unit 312 for judging the threshold value of the domain (area) including the processing result of the CRC-16. In the figure, the CRC-16 processor 311 outputs a 16-bit processing result CRC-16 by which packets are dispersed in the range of values of 0 to 65535 (decimal) by well known CRC-16 processing for the input IP addresses IP_SA and IP_DA (each consisting of 32 bits).

In the area determining unit 312, CMP is a comparator, “A” is an AND gate circuit, and ENC is an encoder circuit. The processing result CRC-16 is input to the terminals A of the comparators CMP1 to CMP7, while the threshold values TH1 to TH7 for the area determination are input to the other terminals B. The comparator CMP1 outputs a comparison output A>B=1 (logic 1 level) when CRC-16≦TH1 and outputs a comparison output A>B=0 (logic 0 level) at other times. Accordingly, the AND gate circuit A1 outputs an area determining signal S0=1 (logic 1 level) within a range of:

0≦CRC-16≦TH1 and outputs an area determining signal S0=0 (logic 0 level) at other times (that is, CRC-16<TH1). Similarly, the AND gate circuit A2 outputs an area determining signal S1=1 within a range of: TH1≦CRC-16≦TH2 and outputs an area determining signal S1=0 in other cases. The same is true for the following. Then, the encoder circuit ENC encodes the area determining signals S0 to S7 and outputs 3 bits of area determining signals SL0 to SL2.

Note that, FIG. 4B diagrammatically shows the relationship between the processing output CRC-16 and areas (threshold values TH1 to TH7) including the values.

Returning to FIG. 2, the IP address table 32 is provided with a content addressable memory (CAM) unit 321 and a usual RAM unit 322, searches through the CAM unit 321 by the destination address IP_DA in the IP header, and acquires a RAM address RAM_ADD in a column including the information of the IP_DA. Further, it obtains the pointer value PT_VAL for searching for the routing information (outgoing port information etc.) in the routing tables RT#1 to RT#8 from the RAM unit 322 according to the RAM_ADD. By this, it becomes possible to flexibly link the destination address IP_DA and the routing information.

Note that “EN” of the CAM unit 321 is a valid/invalid flag of each column. For example, EN=1 means “valid” and EN=0 means “invalid”.

The routing table unit 34 is provided with a plurality of routing tables RT#1 to RT#8 defining different outgoing port information TxPort able to finally reach the destination address IP_DA for the identical destination address IP_DA. Due to this configuration, for the identical destination address IP_DA, when using the routing table RT#l, certain outgoing (transmission) port information TxPort#1 able to finally reach the target destination address IP_DA is selected. If using another routing table RT#2, other outgoing port information TxPort#j able to finally reach the target destination address IP_DA is selected.

The “Label” column of the routing table is the column for storing the label information used for the well known cut-through path connection (for example MPLS: Multi Protocol Label Switch). In the cut-through path connection, the edge router 80 (IP_SW1) (FIG. 5) searches for the information of the outgoing port corresponding to the destination address IP_DA. Each later IP_SW, however, can obtain the outgoing port information directly from the label information “Label” added to the IP packet. Therefore, it becomes possible to greatly shorten the routing delay due to the search for the IP address. The router 80 according to the present embodiment is suitable for application to an edge router (IP_SW1) in such a cut-through path connection system.

The “EN” column of the routing table carries the valid/invalid flag for the column. For example, EN=1 means “valid”, and EN=0 means “invalid”. The “STK” column is a stacking flag indicating whether or not the label information “Label” is placed (stacked) on the IP header. For example, STK=1 means “stack”, while STK=0 means “not stack”.

Note that, for the edge router IP_SW1 of the cut-through path connection, the stacking flag STK is “1”. On the other hand, when the router according to the present embodiment is used at a position other than the edge router, it is possible to make the stacking flag STK “0” and search for the outgoing port information from the destination address IP_DA.

In the routing table IF unit 33, reference numeral 331 is a selector (SEL); 332 is an adder; and 333 is an address register (ADR) for accessing the routing table unit 34. The selector 331 ordinarily selects the side of the area determining information SL0 to SL2. When assuming that the output signal “+1” of the result decision unit 35 is “0”, the upper 3 bits of the area determining information SL0 to SL2 and the lower bit pointer value PT_VAL are set in the ADR 333. The upper 3 bits of the signal RTS0 to RTS2 in the ADR 333 are used as the selection information for selecting the routing tables RT#1 to RT#8, and the lower bit pointer value PPT_VAL is used for reading the routing information of the column (address) corresponding to the pointer value PT_VAL from the selected routing table. By this, input information such as the outgoing port information TxPort, stacked label information “Label”, and the stacking flag STK corresponding to the destination address IP_DA are read from the routing table unit 34.

In the result decision unit 35, the comparison unit 351 compares the information TxPort of the outgoing port read from the routing table unit 34 and the information of the faulty port detected by the fault monitor means (not illustrated). When obtaining a coincidence by that comparison, the output signal “+1”=1 is output. The information of the faulty port referred to here is information of the outgoing port unable to forward the IP packet due to a connection port link down or the like. Due to this, the selector 331 selects the side of the table selection signal RTS0 to RTS2, the adder 332 adds +1 to the output of the selector 331, and the output incremented by “1” is set in the address register 333. Due to this, the next routing table is selected. As a result, the information TxPort of the different outgoing port is read out. This result decision processing is carried out until the information of the outgoing port and the information of the faulty port no longer coincide. When the value of the table selection signal RTS0 to RTS2 becomes “7” during that time, the output of the next addition result becomes “0”. In this way, when the information of the outgoing port and the information of the faulty port no longer match after a while, the outgoing port information TxPort, the stacked label information Label, and the table selection information RTS0 to RTS2 of the search result at that point of time are notified to the transmission control unit 50 (FIG. 3) as the valid information.

In FIG. 3, the shared memory IF unit 51 reads out the related packet from the packet buffer 20 by the flow ID notified from the outgoing route search unit 30. Further, the IP packet is stacked with the label information “Label” and stored in the shared memory 52 together with the related outgoing port information TxPort and table selection information RTS0 to RTS2.

In the transmission scheduler 53, reference numeral 531 is a task scheduler for sending each packet data written in the shared memory 52 to each corresponding transmission buffer together with the related table selection information, while 532 is a read control unit. The task scheduler 531 reads the IP packet from the shared memory 52 according to the well known scheduling method and sends that to the corresponding transmission buffers #1 to #n. As the well known scheduling method, there are for example the round robin method for fairly and sequentially (circularly) giving opportunities for packet forwarding to the transmission buffers #1 to #n and the so-called weighted round robin method (WRR) basically sequentially (circularly) giving opportunities for packet forwarding to the transmission buffers #1 to #n, but performing a preferential weighting for the packet reading to a certain transmission buffer (wideband lines).

The transmission buffer unit 54 is provided with IP packet transmission buffers #1 to #n corresponding to the transmission ports TxPort#1 to TxPort#n. IP packets given the label information “Label” are output to the transmission ports via this transmission buffer.

The flow amount monitor unit 55 detects the flow amount of the packets passing through the transmission port and the information of the routing table routing the packets to the transmission port for every transmission port and changes the threshold value of the table selecting means 2 according to the detected information. The flow amount monitor monitors the packet flow amount in units of predetermined times. At that time, the unit 55 measures the table selection information sent together with the packet data. Then, it tallies the results of measurement of the flow amount at the transmission ports, reviews the load dispersal threshold value information TH1 to TH7 so that the flow amount in all areas can be balanced, and feeds back the result of the review to the area determining unit 312.

The threshold value is changed so that the threshold value range for selecting a routing table for routing packets to for example an outgoing port having a large flow amount becomes narrow. By this, the chance of selection of that routing table is reduced. Accordingly, the number of packets routed to that outgoing port is decreased. Alternatively, the threshold value is changed so that the threshold value range for selecting a routing table for routing packets to an outgoing port having a small flow amount becomes wide. By this, the chance of selection of that routing table increases. Accordingly, the number of packets routed to that outgoing port increases. This work is executed in a cycle according to a balancing review request for the network, for example, 1 hour, 12 hours, 1 day, etc. in accordance with the setting.

FIG. 5 shows forwarding control of IP packets according to this embodiment. In the same way as the case of FIG. 6 explained above, the terminal equipment TE1 to TE3 are connected to the remote terminal equipment (server etc.) TE4 via the IP_NW 100. Here, the router 80 (IP_SW1) according to the present embodiment is positioned as the edge router entering the IP_NW 100. When now assuming that the IP packets A to C are forwarded simultaneously from the terminal equipment TE1 to TE3 to the terminal equipment TE4, the router 80 allots the outgoing routes of the IP packets A to C according to the addresses IP_SA and IP_DA, so the load of the network path can be dispersed. By dispersing the load and sending the packets to a plurality of paths, the forwarding efficiency of the network can be raised.

Note that, in this embodiment, the example of application to IP packets was given, but the invention is not limited to this. The present invention can also be applied to usual packet forwarding.

Also, in the embodiment, as an example of the Hash processing, CRC-16 processing (16 bits) was used, but it is also possible to lower the dispersal precision by using CRC-8 processing (8 bits) etc.

As another Hash processing method, it is also possible to employ a processing method taking, for example, an EOR (exclusive logical OR) between the 32 bits of the destination address IP_DA and the 32 bits of the sender address IP_SA where the MSB's and LSB's thereof are inverted so as to obtain 32 bits and further performing EOR processing between the upper 16 bits and the lower 16 bits to finally obtain the 16 bits of the processing result.

The object of performing the Hash processing in this way is to select a sufficiently separate (that is, lacking mutual correlation) routing table even among a plurality of combinations of SA and DA with identical destination addresses IP_DA and slightly different (that is, similar) sender addresses IP_SA.

In this embodiment, control of a packet switch using the shared memory 52 was explained, but the present invention is not limited to this. For example, it is also possible to configure this part by a large scale switch such as cross-bar switch.

In this embodiment, the upper 3 bits of the table selection signal RTS0 to RTS2 of the address register 333 were used for selecting the planes of the routing tables RT#1 to RT#8, but the present invention is not limited to this. For example, it is also possible to use the bits of the selection signal RTS0 to RTS2 for the lower bits of the ADR333 and thereby use the same as the signal for selecting 8 types of table columns.

Further, the embodiment was explained accompanied by concrete numerical examples, but the present invention is not limited to these numerical examples.

Further, while a preferred embodiment of the present invention was explained, needless to say a variety of modifications of the configuration, control, and processing of the units and the combinations of the same can be made within a range not out of the spirit of the present invention.

As explained above, according to the present invention, it becomes possible to balance (disperse) the traffic load of a packet forwarding network to different paths. This greatly contributes to improvement of the performance of the packet forwarding network.

While the invention has been described with reference to specific embodiments chosen for purpose of illustration, it should be apparent that numerous modifications could be made thereto by those skilled in the art without departing from the basic concept and scope of the invention.

What is claimed is:

1. A packet switch comprising:
a plurality of routing tables allotted with information of different outgoing ports for at least one destination address;
a table selecting function unit which selects any of said plurality of routing tables in accordance with a combination of at least a sender address and the destination address of an incoming packet; and
a switch function unit which sends said incoming packet to the outgoing port allotted to the destination address in the selected routing table.

2. A packet switch as set forth in claim 1, wherein provision is made of a selection changing function unit which re-selects another routing table when detecting that the outgoing port obtained from said selected routing table is a faulty port and then sending the packet to the outgoing port allotted to said destination address in the re-selected routing table.

3. A packet switch for sending an incoming packet to a corresponding outgoing port in accordance with a destination address thereof comprising:
a plurality of routing tables defining information of different outgoing ports able to reach a destination address with respect to an identical destination address;
a table selecting function unit which performs predetermined processing for information of a pair of a sender address and destination address of an incoming packet and selecting the corresponding routing table based on a result of judgement of a predetermined threshold value for the value obtained by the processing; and
a switching function unit which searches through said selected routing table with the destination address of said incoming packet and sending said packet to the route based on the information of the outgoing port obtained by the search.

4. A packet switch as set forth in claim 3, further comprising a selection changing function unit which compares the information of the outgoing port obtained from the routing table and the information of a separately detected faulty port and, when they coincide, changing the selection of the routing table.

5. A packet switch as set forth in claim 3, further comprising:
a detecting function unit which detects information of a flow rate of packets passing through the outgoing port and the routing table routing the packets to an outgoing port for every outgoing port and a threshold value changing function unit which changes the threshold value of the table selecting function unit according to said detected information.

6. A packet switch as set forth in claim 3, further comprising a function unit which stacks label information on the outgoing packet for reference in routing control by a cut-through path connection method.

7. A packet forwarding method for forwarding an incoming packet to a corresponding outgoing route according to a destination address thereof, comprised of:
a step of providing a plurality of routing tables defining information of different outgoing ports able to reach a destination address for the same destination address;
a step of performing predetermined processing with respect to the information of a pair of a sender address and destination address of an incoming packet and selecting a corresponding routing table based on the result of judgement of a predetermined threshold value for a value obtained by the processing; and
a step of searching through the selected routing table by the destination address of the incoming packet and forwarding the packet to the route based on the information of the outgoing port obtained by the search.

8. A packet forwarding method as set forth in claim 7, further comprising a step of comparing the information of the outgoing port obtained from the routing table and the information of a separately detected faulty port and, when they coincide, changing the selection of the routing table.

9. A packet forwarding method as set forth in claim 7, further comprising:
a step of detecting information of a flow amount of packets passing through the outgoing port and the routing table routing packets to an outgoing port for every outgoing port; and
a step of changing the threshold value of the table selection according to the detected flow amount.
